(19) United States
(12) Patent Application Publication
(10) Pub. No.: US 2026/0195869 A1
(43) Pub. Date: Jul. 9, 2026

(54) FEATURE PRESERVING PROCESS FOR NOISE REMOVAL FROM SEISMIC IMAGES

(71) Applicant: Saudi Arabian Oil Company, Dhahran (SA)

(72) Inventors: Qiang Fu, Dhahran (SA); Saleh A. Dossary, Dammam (SA); Bander K. Jumah, Dhahran (SA)

(21) Appl. No.: 19/011,202

(22) Filed: Jan. 6, 2025

(51) Int. Cl. G06T 5/70

(52) U.S. Cl. CPC G06T 5/70; G06T 2207/30181

(57) ABSTRACT

Systems and methods are for generating high-resolution seismic images for hydrocarbon exploration. A data processing system is configured to generate the high-resolution seismic images by processing seismic data (such as seismic trace data) that is measured from acoustic signals received from sensors in a subsurface region. The data processing system is configured to remove noise from the seismic data and also preserving the information of geological features in the generated seismic images. The systems and methods described herein include a searching operator and a smoothing operator that are configured to process seismic data and/or seismic images. These operators are efficient and independent of one another and are therefore fully parallelizable with one another. The operators are configured to generate seismic images that have minimal noise without removing data representing geological features.

### TECHNICAL FIELD

This specification relates generally to geophysical exploration, and more particularly to seismic surveying and processing of seismic data.

### BACKGROUND

In reflection seismology, geologists and geophysicists perform seismic surveys to map and interpret geologic features (including sedimentary facies) for applications including identification of potential petroleum reservoirs. Seismic surveys are conducted by using a controlled seismic source (for example, a seismic vibrator or dynamite) to create seismic waves. The seismic source is typically located at earth surface (either onshore or offshore). Seismic waves travel into the ground, reflected by subsurface formations, and return to the surface where they recorded by sensors (geophones and hydrophones). Seismic surface waves travel along the ground surface and diminish as they get further from the surface. The geologists and geophysicists analyze the information carried by both the travel time and the waveform of the seismic waves to reflect off subsurface formations and return to the surface to map subsurface media properties, structures, and geologic features. Similarly, analysis of the information it takes seismic surface waves to travel from source to sensor can provide information about near surface features. This analysis can also incorporate data from sources, for example, borehole logging, gravity surveys, and magnetic surveys.

In geology, sedimentary facies are bodies of sediment that are recognizably distinct from adjacent sediments that resulted from different depositional environments. Generally, geologists distinguish facies by aspects of the rock or sediment being studied. Seismic facies are groups of seismic reflections whose parameters (such as amplitude, continuity, reflection geometry, and frequency) differ from those of adjacent groups. Seismic facies analysis, a subdivision of seismic stratigraphy, plays an important role in hydrocarbon exploration and is one key step in the interpretation of seismic data for reservoir characterization. The seismic facies in a given geological area can provide useful information, particularly about the types of sedimentary deposits and the anticipated lithology.

One approach to this analysis is based on cross-correlation along each continuous reflector throughout the dataset produced by the seismic survey to produce structural maps that reflect the spatial variation in depth of certain facies. These maps can be used to identify impermeable layers and faults that can trap hydrocarbons such as oil and gas.

### SUMMARY

This specification describes systems and methods for generating high-resolution seismic images for hydrocarbon exploration. A data processing system is configured to generate the high-resolution seismic images by processing seismic data (such as seismic trace data) that is measured from acoustic signals received from sensors in a subsurface region. The data processing system is configured to remove noise from the seismic data and also preserving the information of geological features in the generated seismic images. The systems and methods described herein include a searching operator and a smoothing operator that are configured to process seismic data and/or seismic images. These operators are efficient and independent of one another and are therefore fully parallelizable with one another. The operators are configured to generate seismic images that have minimal noise without removing data representing geological features.

Seismic migration geometrically re-locates a reflection event to a location in which the event actually occurred in the subsurface rather than the location that in which appears in the seismic data. The representation, such as shape, location, etc. of geological features may be changed in seismic processing, but the information is preserved.

Geophysical exploration for oil and gas utilizes seismic reflection surveys to image the subsurface geological structures. The seismic surveys generate seismic waves (e.g., acoustic waves) that travel through the subsurface and reflect from different earth layers. Seismic receivers measure the reflected waves. The sensors generate seismic data representing the reflections, such as how long the signal took to reflect from the seismic source to that particular receiver, and how large is the reflection signal amplitude.

Seismic imaging is a process to extract information from seismic data that will enable a visualization of subsurface structures. The result of imaging process is called a seismic image. Seismic data can be noisy because of various factors, such as environmental or instrumental disturbances, or random changes in the reflection or refraction of the waves due to geological features like anomalies, fractures, gas chimneys, and so forth. A data processing system can process the seismic data to remove the noise so that the seismic image accurately represents subsurface geology. The seismic images can enable identification of locations of hydrocarbon reservoirs within the subsurface, and therefore guide drilling decisions for new wells.

The data processing system is configured to remove the noise from the seismic signals. In some workflows, removing noise from the seismic signal may remove details from the seismic data that identify geological features. The data processing system described herein is configured to remove noise from the seismic data for generation of a high-resolution seismic image while ensuring that a representation of the geological features in the data or image remains intact. The data processing system performs a process for feature preserving smoothing in the seismic data or images that provides increased image resolution and/or reduced noise relative to methods based on edge preserving smoothing.

The generated seismic images of the feature preserving smoothing processing of the seismic data are inputs for interpretation by a human interpreter, a machine-based algorithms (AI), or a combination thereof. As subsequently described, the process can be implemented in a parallelized architecture which enables higher runtime efficiency on multi-processor computers or multi-node cluster computing hardware relative to previous, serialized seismic image generation.

The approaches described in this specification provide systems and methods that provide the following advantages. The feature preserving smoothing process for data processing can provide benefits of increased seismic image resolution and faster processing time relative to conventional serial edge preserving smoothing process for removing noise for seismic imaging. As further described herein (e.g., in the quality comparison shown in FIGS. 9A-10B), the feature preserving smoothing process for data processing enables a better noise removal result compared to conventional edge-preserving process. The seismic images have less noise and retain more of the signal relative to conventional approaches. The improved quality of the seismic images facilitates interpretation directly for placement of wells or reduces downstream errors for further processing and/or imaging operations for hydrocarbon production. Quality improvements are shown herein by real data examples.

The quality of the results for the feature-preserving process is much better and more desirable for both human seismic interpreters and future machine-based algorithms. The generated seismic image outputs described herein are free of data processing artifacts such as artificial boundaries and patchified effects introduced by edge preserving processes. The generated seismic images from the feature-preserving process are meaningful for human interpreters and computer algorithms.

The data processing system can parallelize the execution of operators for the smoothing iteration portion of the data processing process. Specifically, an image convolution by an orientation operator (also called a searching operator) can be parallelized with an image convolution using a smoothing operator. These operators are iterated on the processed images to reduce noise and preserve geological features. Because the iterated portion of the process is parallelizable, the reduction in processing time is compounded. The smoothing operator and the orientation operator do not depend on each other for execution and can be executed in any order for each iteration or executed simultaneously for each iteration.

The feature-preserving process reduces a processing overhead for noise removal from the seismic images. In an example, each step of the feature preserving processing is local to a region of the image. Specifically, only 3 adjacent elements in each orientation can be involved for each operator. Each operator is simplified. For example, only vector addition and dot product can be used in each operator. Each operator is fully vectorized. For example, each of the 13 components can be completely independent each other. Due to the simplicity of both operators, the data processing system can use specialized hardware to accelerate the execution and increase efficiency of the execution. For example, the data processing system can be implemented by a programmable hardware (e.g., a field programable gate array (FPGA)) or non-programable hardware (e.g., an application specific integrated circuit (ASIC)) to obtain even higher speed and efficiency relative to general computing hardware. The operators of the feature-preserving process described herein tenable flexibility for hardware implementation, and the data processing system can utilize the full power of a parallel computer system or even specific computational hardware (cluster, GPU, FPGA, ASIC, etc.).

The process described herein increase a flexibility to use different searching operator and smoothing operator. The data processing system can replace either operator (e.g., the smoothing operator or the searching operator) by other implementations without requiring that the other operator be altered or re-executed. The process is therefore more flexible because the searching operator and the smoothing operator are independent and even can be combined by different operators within one dataset. In another example, different combinations of operators can be used for different reservoirs or geological scenarios within one dataset to balance the cost and quality.

Embodiments of these systems and methods can include one or more of the following features.

In an aspect, method for performing seismic imaging of a subsurface region includes receiving seismic data comprising at least one seismic image representing a subsurface region comprising at least one geological feature; executing, over a set of sample data points in the seismic image, an orientation operator configured to select a smoothing direction, from each sample data point, having a higher coherence for values in the seismic image relative to another direction from each sample data point to generate orientation data for each sample data point; executing, over the set of sample data points in the seismic image, a smoothing operator configured to perform a smoothing operation for each candidate direction from each sample data point of the set of sample data points to generate smoothing data for each sample data point; performing, based on the smoothing data for each sample data point and the orientation data for each sample data point, a reduction operation to generate a smoothest component from each sample data point of the set of sample data points; and generating, based on the smoothest component from each sample data point, an output seismic image representing the subsurface region that preserves the at least one geological feature and reduces a noise present in the at least one seismic image.

In some implementations, the output seismic image is free of artificial boundaries or patchified effects. In some implementations, the orientation operator and the smoothing operator are executed in parallel. In some implementations, either the orientation operator, the smoothing operator, or both are three-dimensional operators.

In some implementations, the method further includes selecting a type of the smoothing operator or the orientation operator or both based on a particular geographic location or geology represented in the at least one seismic image.

In some implementations, the smoothing operator, the orientation operator, or both include a vectorized convolution operator.

In some implementations, the orientation operator and the smoothing operator are executed using a field programable gate array or an application specific integrated circuit.

In an aspect, a system for performing seismic imaging of a subsurface region, includes a memory; and at least one processor in communication with the memory, the at least one processor configured to execute instructions stored by the memory to perform operations of any of the methods described herein.

In an aspect, one or more non-transitory computer readable media storing instructions for performing seismic imaging of a subsurface region, wherein the instructions, when executed by at least one processor, cause the at least one processor to perform operations of any of the methods described herein.

The details of one or more embodiments are set forth in the accompanying drawings and the description below. Other features and advantages will be apparent from the description and drawings, and from the claims.

### BRIEF DESCRIPTION OF THE DRAWINGS

FIG. 1 is a schematic view of a seismic survey being performed to map subterranean features such as facies and faults.

FIG. 2 illustrates a three-dimensional (3D) cube representing the seismic data in the CMP-offset domain.

FIG. 3 illustrates a stratigraphic trace extracted by a bin of the 3D cube of FIG. 2.

FIGS. 4A-4B each illustrate a convolution operation.

FIG. 5 is a flow diagram that illustrates a feature preserving process for seismic data noise removal.

FIG. 6 illustrates a convolution operation for seismic data noise removal.

FIG. 7 is a flow diagram that illustrates a feature preserving process for seismic data noise removal.

FIG. 8A shows an example of coefficient values for a convolution operator.

FIG. 8B shows an example of coefficient values for a convolution operator.

FIGS. 9A-9C each shows an example of a seismic image.

FIGS. 10A-10B each shows an example of a seismic image for fault detection.

FIG. 11 is a flow diagram that illustrates an example process.

FIG. 12 illustrates example hydrocarbon production operations.

FIG. 13 is a diagram of an example data processing system.

### DETAILED DESCRIPTION

This specification describes systems and methods for generating high-resolution seismic images for hydrocarbon exploration. The process can be called a feature-preserving process in which geological features (and not merely edges) are preserved in the seismic images while noise is removed. A data processing system is configured to generate the high-resolution seismic images by processing seismic data (such as seismic trace data) that is measured from acoustic signals received from sensors in a subsurface region. The data processing system is configured to remove noise from the seismic data and also preserving a representation of geological features in the generated seismic images. The systems and methods described herein include a searching operator and a smoothing operator that are configured to process seismic data and/or seismic images. These operators are efficient and independent of one another and are therefore fully parallelizable with one another. The operators are configured to generate seismic images that have minimal noise without removing data representing geological features. The feature preserving process is efficient and is suitable for parallel computation hardware (e.g., a graphical processing unit (GPU), an FPGA, an ASIC, etc.). The operators are fully parallelizable and interchangeable with other operators. For example, either the smoothing operator or the searching operator can be matched or replaced with other implementations without requiring re-execution of the remaining operator(s). The process is flexible because the smoothing operator and the searching operator are independent and even can be combined with different operators within one dataset.

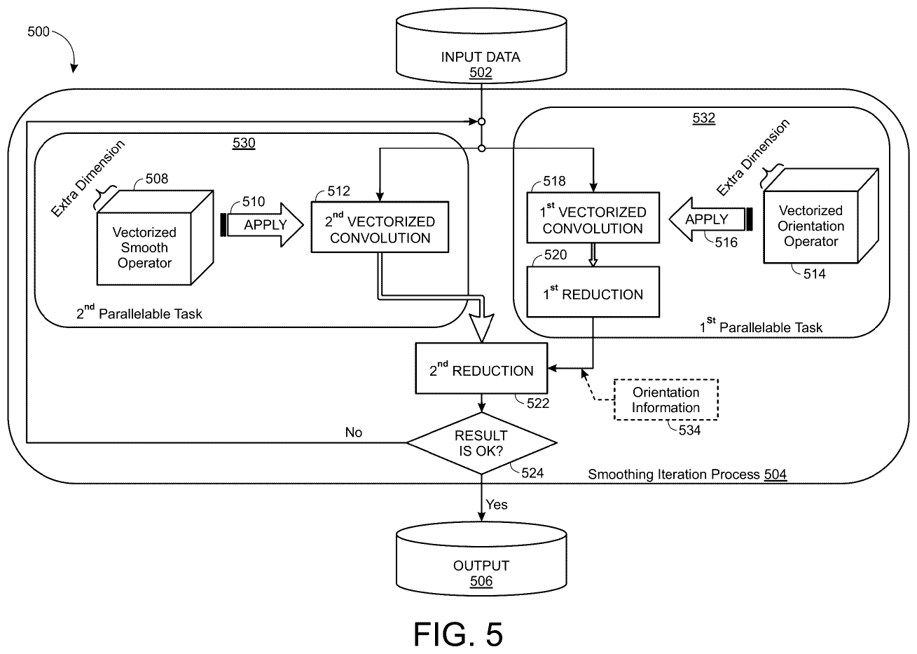

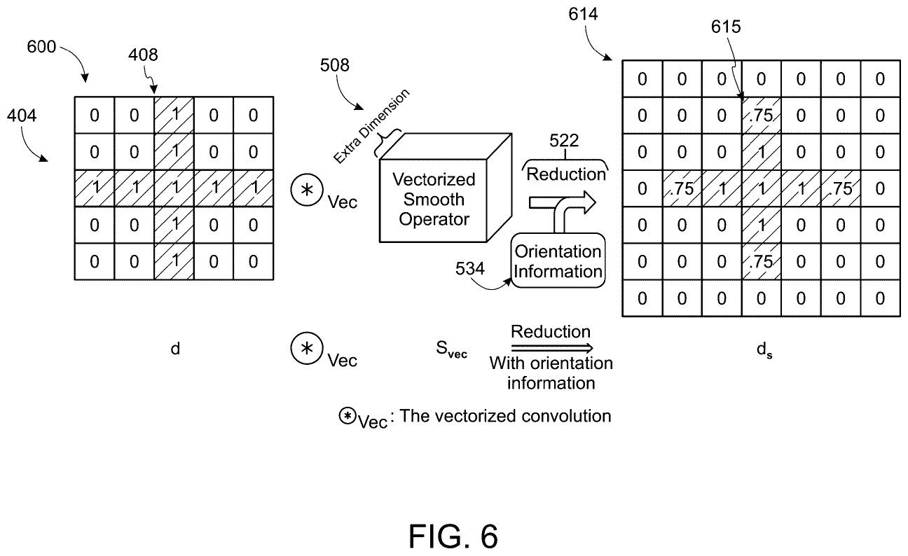

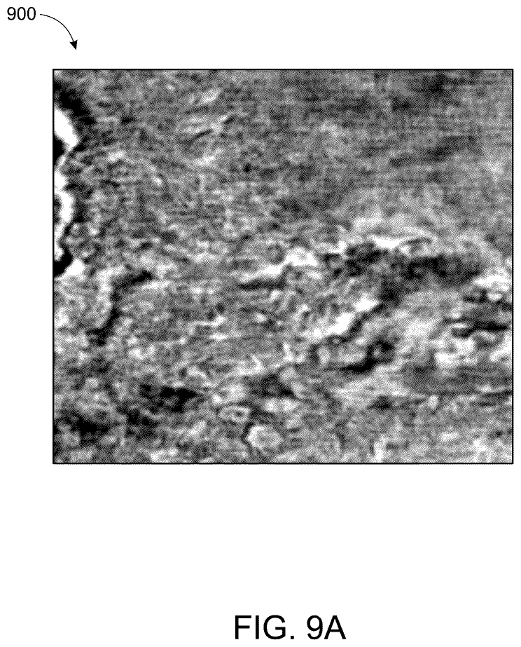

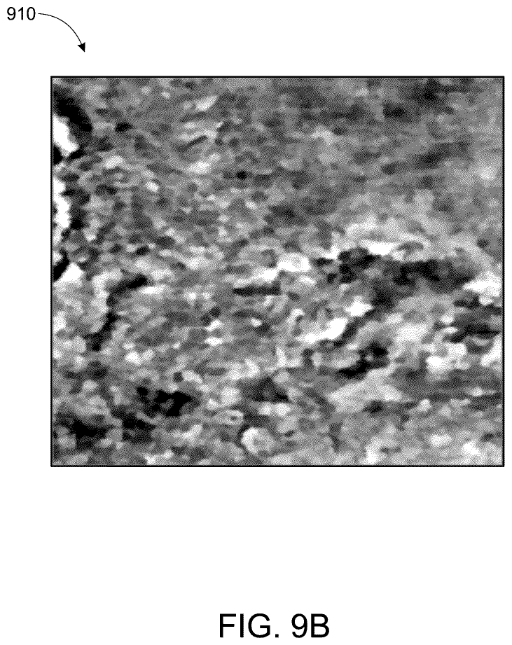

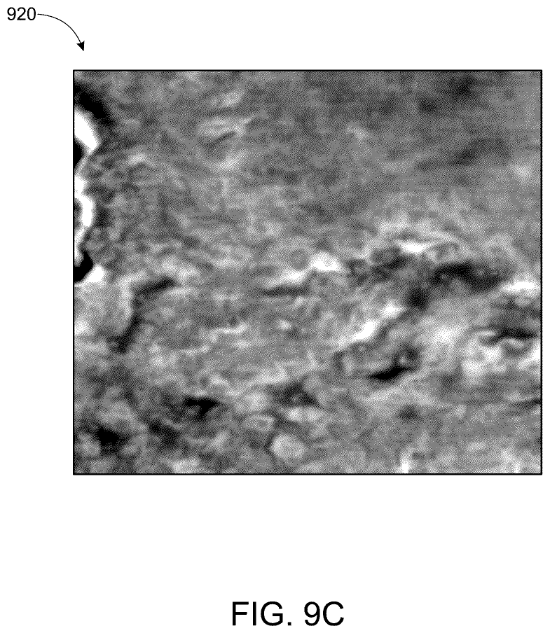

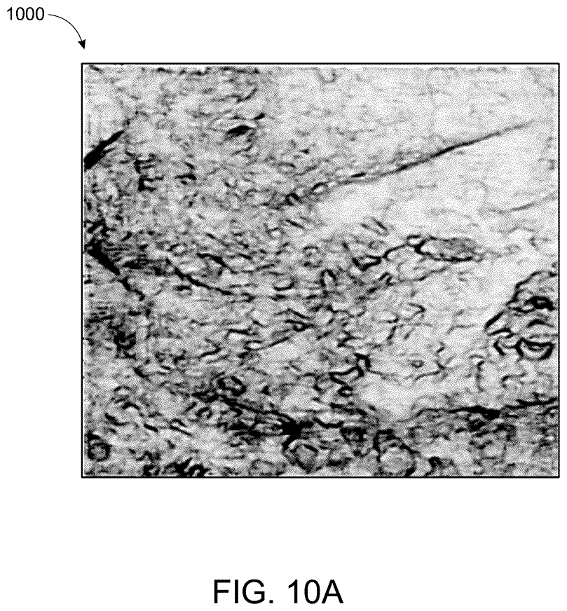

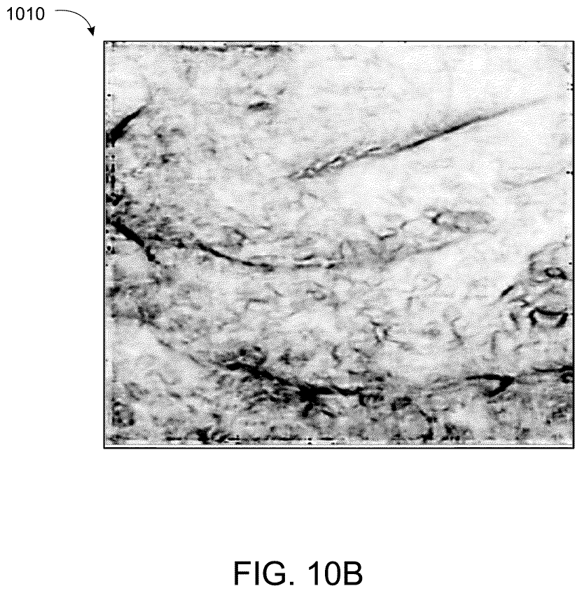

The process described herein is configured to find a most coherent direction to smooth within a seismic image, relative to other potential smoothing directions within the seismic image, for a given location within the seismic image. This searching criterion is independent of the performance and execution of the smoothing operator. The independent search operator provides the data processing system the capability to accurately control the output and to ensure a more desirable result, as described in relation to FIGS. 9A-10B. The data processing system can use a different searching operator and/or a different smoothing operator with one another. The data processing system can change which direction is considered the most coherent by using different searching operators for the searching task described in relation to FIG. 5 without requiring a re-execution of the smoothing operator, described in relation to FIG. 6. Rather, the data processing system can simply execute the second reduction. Similarly, the data processing system can change the other smoothing operator without to re-executing the search operator for obtaining direction information. The data processing system can combine different searching operators for different geological scenarios within one dataset to balance cost of the survey and the quality of the output.

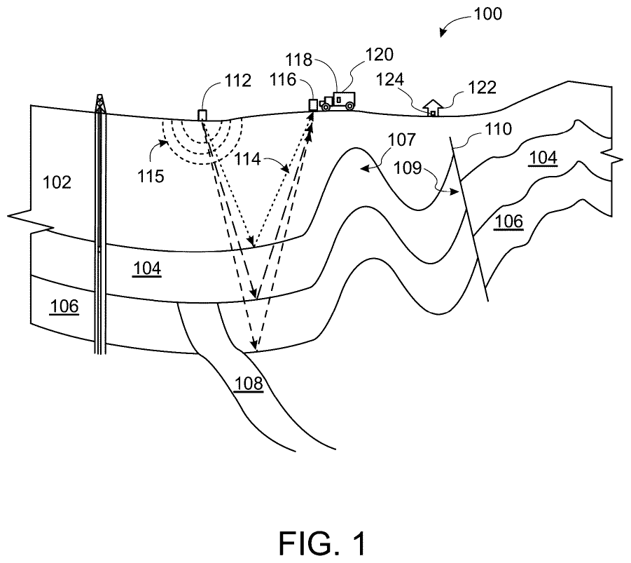

FIG. 1 is a schematic view of a seismic survey being performed to map subterranean features such as facies and faults in a subterranean formation 100 under a marine feature (such as under the sea or ocean). The subterranean formation 100 includes a layer of impermeable cap rock 102 at the surface. Facies underlying the impermeable cap rocks 102 include a sandstone layer 104, a limestone layer 106, and a sand layer 108. A fault line 110 extends across the sandstone layer 104 and the limestone layer 106.

Oil and gas tend to rise through permeable reservoir rock until further upward migration is blocked, for example, by the layer of impermeable cap rock 102. Seismic surveys attempt to identify locations where interaction between layers of the subterranean formation 100 are likely to trap oil and gas by limiting this upward migration. For example, FIG. 1A shows an anticline trap 107, where the layer of impermeable cap rock 102 has an upward convex configuration, and a fault trap 109, where the fault line 110 might allow oil and gas to flow in with clay material between the walls traps the petroleum. Other traps include salt domes and stratigraphic traps.

A seismic source 112 (for example, a seismic vibrator or an explosion) generates seismic waves that propagate in the earth. Although illustrated as a single component in FIG. 1, the source or sources 112 are typically a line or an array of sources 112. The generated seismic waves include seismic body waves 114 that travel into the ground and seismic surface waves 115 travel along the ground surface and diminish as they get further from the marine surface.

The velocity of these seismic waves depends on properties, for example, density, porosity, and fluid content of the medium through which the seismic waves are traveling. Different geologic bodies or layers in the earth are distinguishable because the layers have different properties and, thus, different characteristic seismic velocities. For example, in the subterranean formation 100, the velocity of seismic waves traveling through the subterranean formation 100 will be different in the sandstone layer 104, the limestone layer 106, and the sand layer 108. As the seismic body waves 114 contact interfaces between geologic bodies or layers that have different velocities, each interface reflects some of the energy of the seismic wave and refracts some of the energy of the seismic wave. Such interfaces are sometimes referred to as horizons.

The seismic body waves 114 are received by a sensor or sensors 116. Although illustrated as a single component in FIG. 1, the sensor or sensors 116 are typically a line or an array of sensors 116 that generate an output signal in response to received seismic waves including waves reflected by the horizons in the subterranean formation 100. The sensors 116 can be geophone-receivers that produce electrical output signals transmitted as input data, for example, to a computer 118 on a seismic control truck 120. Based on the input data, the computer 118 may generate a seismic data output, for example, a seismic two-way response time plot.

The seismic surface waves 115 travel more slowly than seismic body waves 114. Analysis of the time it takes seismic surface waves 115 to travel from source to sensor can provide information about near surface features.

A control center 122 can be operatively coupled to the seismic control truck 120 and other data acquisition and wellsite systems. The control center 122 may have computer facilities for receiving, storing, processing, and analyzing data from the seismic control truck 120 and other data acquisition and wellsite systems. For example, computer systems 124 in the control center 122 can be configured to analyze, model, control, optimize, or perform management tasks of field operations associated with development and production of resources such as oil and gas from the subterranean formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subterranean formation or performing simulation, planning, and optimization of production operations of the wellsite systems.

In some embodiments, results generated by the computer systems 124 may be displayed for user viewing using local or remote monitors or other display units. One approach to analyzing seismic data is to associate the data with portions of a seismic cube representing the subterranean formation 100. The seismic cube can also display results of the analysis of the seismic data associated with the seismic survey.

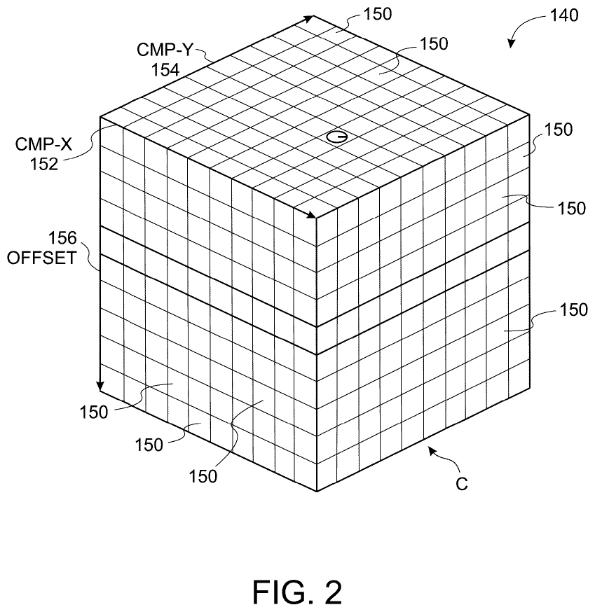

FIG. 2 illustrates seismic trace sorting into CMP-offset bins 150. The multi-dimensional attribute cubes or bins are used for quality control since these cubes or bins 150 enable a visualization of the spatial trends of the travel time (mean values) and the noisy areas (standard deviation). When performing the 3D CMP-offset binning (that is, XYO binning in the directions of CMP-X 152, CMP-Y 154, and offset 156), the bin sizes in the CMP-X 152 and CMP-Y 154 directions can be kept greater, such that a sufficient number of CMPs are placed in a bin 150 to provide functionally applicable statistics. The XYO binning illustrated in FIG. 2 is different from sorting in a common offset domain as the latter collects data sharing a common offset but pertaining to different CMPs. The existing CMP sorting (time-offset) that is applied for reflected waves is less useful for refracted waves as it would display events with variable velocities over the offset axis. The XYO binning method is therefore an effective representation of both CMP and offset domains where common properties at a CMP position can be assessed.

In some implementations, as shown in FIG. 2, the XYO space 140 is divided into XYO cubes or bins 150 of a particular size. For example, each bin 150 can have a size of 100 meters (m) in the CMP-X direction, 100 m in the CMP-Y direction, and 50 m in the offset direction. For each trace (or first break pick), the offset (the distance between the source and the receiver) and the CMP (the middle point position between the source and the receiver) are determined, and the trace is sorted into a particular bin based on the offset and the CMP. Each XYO bin 150 includes a collection of traces sharing a common (or similar) midpoint position and a common (or similar) offset. The collection of traces in an XYO bin is sometimes referred to as an XYO gather.

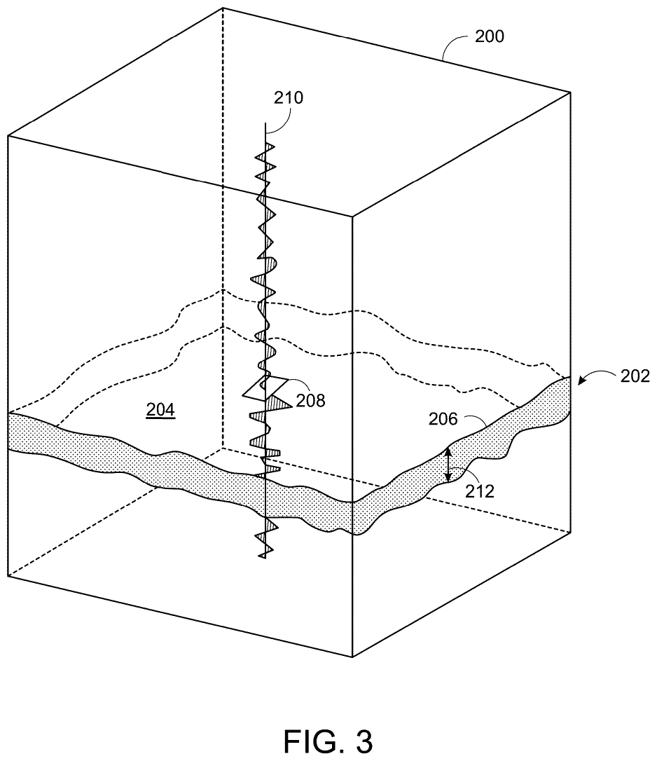

FIG. 3 illustrates a seismic cube 200 representing a formation. The seismic cube has a stratum 202 based on a surface (for example, an amplitude surface 204) and a stratigraphic horizon 206. The amplitude surface 204 and the stratigraphic horizon 206 are grids that include many cells such as exemplary cell 208. Each cell is a sample of a seismic trace representing an acoustic wave. Each seismic trace has an x-coordinate and a y-coordinate, and each data point of the trace corresponds to a certain seismic travel time or depth (t or z). For the stratigraphic horizon 206, a time value is determined and then assigned to the cells from the stratum 202. For the amplitude surface 204, the amplitude value of the seismic trace at the time of the corresponding horizon is assigned to the cell. This assignment process is repeated for all of the cells on this horizon to generate the amplitude surface 204 for the stratum 202. In some instances, the amplitude values of the seismic trace 210 within window 212 by horizon 206 are combined to generate a compound amplitude value for stratum 202. In these instances, the compound amplitude value can be the arithmetic mean of the positive amplitudes within the duration of the window, multiplied by the number of seismic samples in the window.

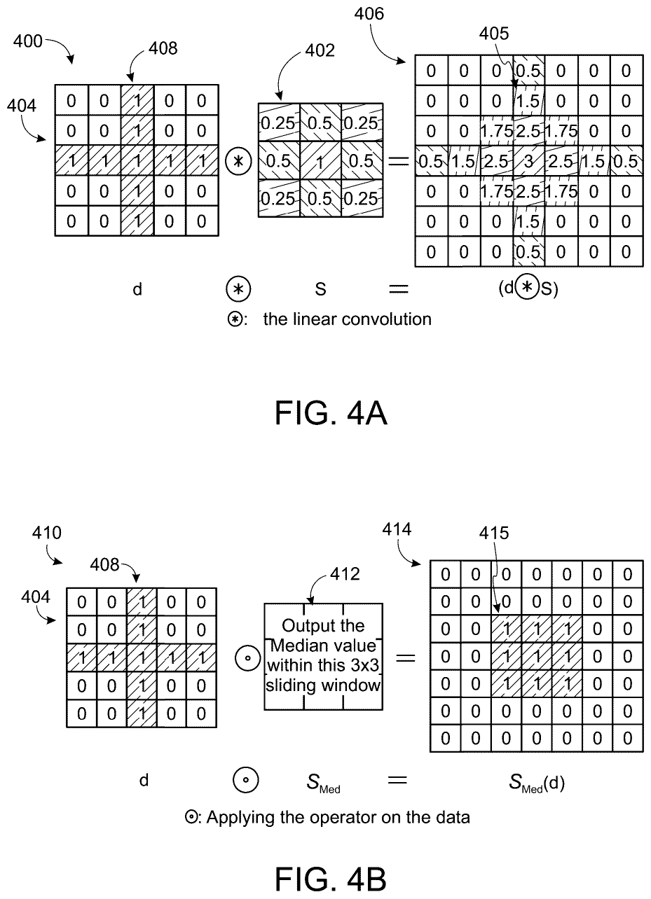

FIGS. 4A-4B each illustrate a respective convolution operation. Numerous methods are possible for noise removal in seismic exploration. One example includes a smooth method, which can be divided into two categories: linear smoothing and non-linear smoothing processes.

FIG. 4A shows an example process 400 including an operator 402 for a linear smooth method. A linear smooth operator with sliding-window can remove noise in seismic data and/or seismic images. A linear smoothing operator is convolved with input data:

$$d \text{?} s = {d}_{s} , \qquad ( 1 )$$

where d is the input data, s is the linear smooth operator, \textcircled{*} denotes the linear convolution operation, and dₛ is the output. To improve the results for this approach, different implementations of the smoothing operator s can be chosen (e.g., a Gaussian smooth, triangle smooth, etc.). Different example parameters are possible. An isotropic smoothing operator s can be used to achieve certain orientation-dependent behavior). An adaptive sliding-window size (e.g., fixed size or adaptive size) can be used. A non-stationary operator s can be used in which the operator s is variant within different sliding-windows. In some implementations, a combination of some or all aforementioned efforts together can be used.

The conventional linear smooth method 400 is shown in an ideal case with no noise. In a two-dimensional (2D) image 404, for example, there is a crossing shape feature 408 that includes pixels of constant value 1, and all the background pixels are all 0. The data processing system applies a 2D smoother the image 404, and the result 406 is shown. The result 406 shows that a shape is changed, as the crossing shape feature 408 becomes a star shape feature 405. The amplitude consistency is broken because a constant amplitude along the feature becomes a graduate decaying amplitude along the feature.

FIG. 4B shows an example process 410 including an operator 412 for a non-linear smooth method with a median value smoothing operator. A non-linear smooth operator with sliding-window can remove noise in seismic data and/or seismic images. The linear smoothing process 400 is unable to in preserve the feature 408 in the input data, whereas the non-linear smooth can, depending on the type used. The median value smoothing operator 412 is shown as an example of this capability. For the 2D image 406 with crossing shape feature 408, the data processing system applies a 2D median value smoothing operator 412 to generate the result image 414 using equation (2):

$${S}_{M e d} ( d ) = {d}_{S Med} , \qquad ( 2 )$$

where d is the input data, S_{Med} is the non-linear median value smoothing process, S_{Med}(d) denotes applying the non-linear median value smoothing process on the data d, and dₛ Med is the smoothed output. The median value smoothing is a non-linear operation. A functional style notation S_{Med}(d) to denotes this operation.

While the amplitude consistency is preserved, the feature shape is completely changed from a crossing shape 408 to a square shape 415. The feature is not preserved with this operator.

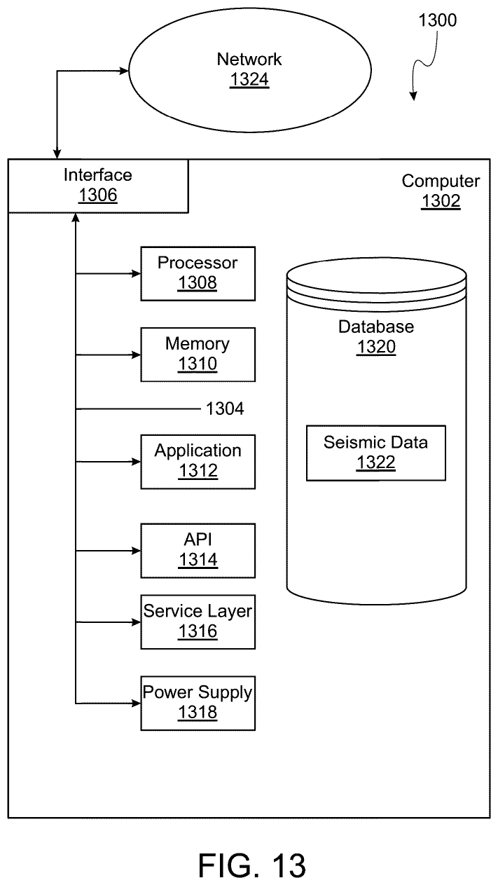

FIG. 5 is a flow diagram that illustrates a feature preserving process 500 for seismic data noise removal. The process 500 includes operators 508, 514 each to perform a respective task 530, 532. A first task 532 includes searching for the smoothest orientation in a neighborhood around each data sample point of three-dimensional (3D) seismic data or an image cube. The second task 530 is configured to smooth the seismic data or seismic image cube along the selected orientation in neighborhood. The type of operators 508, 514 selected and the configuration of the process 500 enables a data processing system (e.g., computing system 1300, described in relation to FIG. 13) to perform the tasks 530, 532 quickly (reducing processing latency), efficiently (reducing processing overhead), and effectively (enabling reduction or elimination of noise while preserving geological features). The process 500 can be performed for either or both of 2D and 3D data. Here, example data are 2D for simplicity. In 3D cases, a cube operator is used for 3D data instead of a square operator used for 2D data.

The process 500 includes the following steps. Input data 502 are received from a data source, such as a database. The input data can be seismic data or seismic images generated from raw seismic data. The data processing system processes the input data 502 using an iterative smoothing process 504. The iterative process 504 includes each of the first parallelizable task 532 and the second parallelizable task 530. In some implementations, the process is used for either the pre-stack domain or post-stack domain.

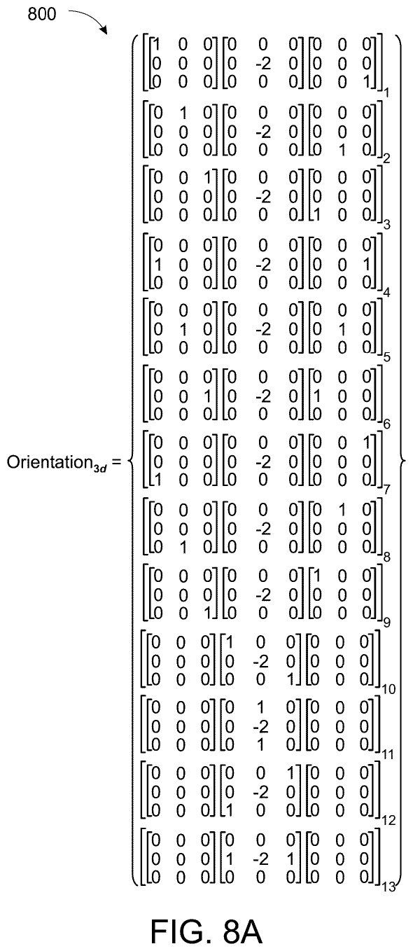

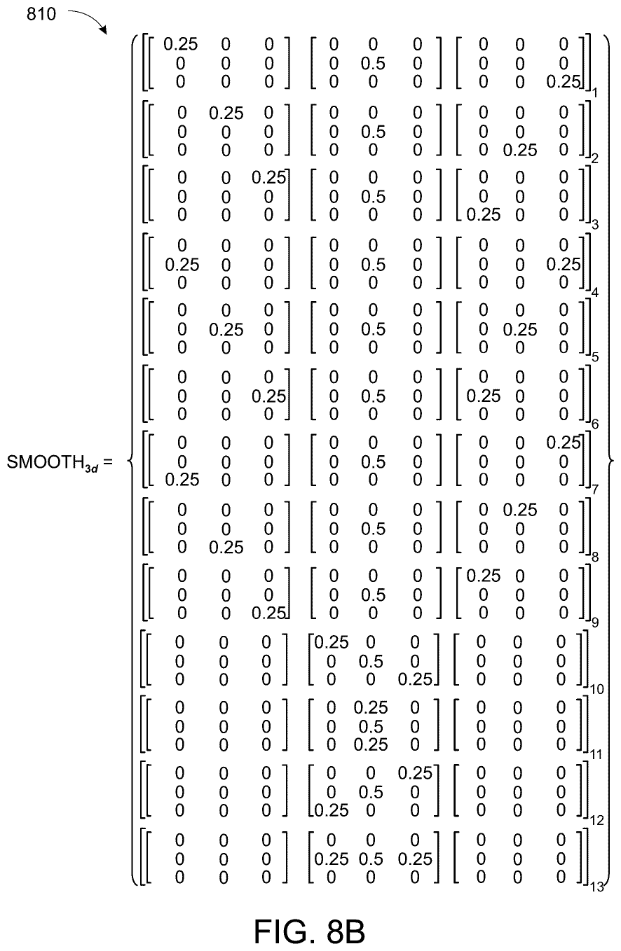

The first parallelizable task 532 includes execution of the orientation operator 514. The orientation operator selects a smoothest orientation near the current data sample point in the image that is being processed. The operator 514 includes operator coefficients that are subsequently described in relation to FIG. 8A.

The operator chooses the smoothest orientation in the image. The smoothest orientation represents a direction from the sample data point with the lowest gradient or value change for a given vector from the sample data point. The operator 514 is applied (516) to the seismic image to generate first vectorized convolution data 518. A first reduction process 520 is performed to generate first reduction data. The first reduction data representing orientation data 534 are input into a second reduction process 522 along with an output from the second parallelizable task 530. The operator 514, the convolution process 518, the first reduction operation 520 of the orientation operation 532, and the second reduction operation 522 are subsequently described in further detail.

The second parallelizable task 530 includes execution of the smoothing operator 508. The smoothing operator 508 removes noise from the seismic image, as is described further in relation to FIG. 8B. The operator is applied (510) to generate a second vectorized convolution data 512. The convolution output data of the second parallelizable task 530 are input into the second reduction process 522 along with the output of the first parallelizable task 532. The operator 508 and convolution 512 processes are subsequently described in further detail.

The operators 530, 532 are executed iteratively based on a result of the smoothing process. A second reduction 522 is performed based on the smoothing direction indicated by the first operator 532. If the resulting data is smooth enough at validation step 524, when the resulting seismic image is output to an output data store 506 for use for hydrocarbon exploration. If the image is still too noisy, the process 504 is repeated. The threshold smoothness can be set based on a particular use case for the generated seismic images.

The iteration number can be determined mainly based on the implementation. Extra iterations will not damage the results. In addition, the data processing system can perform more iterations from where it stopped, if needed, if the previous result is not good enough. The pause can be performed without any penalty in which a previous run iteration is rerun. Usually, the data from same survey or area use a same or similar iteration number, and the final iteration can be found heuristically.

To ensure that the smoothing operations cause a least possible distortion to the geological features in the seismic data/image, the operators are chosen to be simple, the parameters of the operator are conservative in the smoothing magnitude, and the size of the operator is made to be as small as practical. To compensate the conservative parameter choice, the smoothing iteration 504 is performed to achieve satisfactory noise removal. To increase the efficiency, a vectorized convolution is used (e.g., operations 512, 518) rather than a linear convolution. The two vectorized convolutions 512, 518 of the two tasks 530, 532 (operators) are completely independent. The two tasks 530, 532 (operators) can be performed in any order (either one after the other or even simultaneously). Because of the vectorized convolution operations 512, 518, each of the two operators itself can be parallelized.

The process 500 has two levels of parallelization. In a first parallelization level, the two tasks of orientation searching 532 and the smoothing 530 can be parallelized. The smoothing task 530 does smoothing in each candidate direction. The final result direction is chosen based on the orientation searching operator 532 result, which is preformed parallel (can be concurrent or not) with the smoothing operator 530. Using parallel computation hardware, the process 500 performed in this way is much more efficient than choosing a direction first and subsequently smoothing the image data. In a second level, each of the vectorized-convolution operators can be parallelized for each component of the extra dimension, because we designed the operators as simple as possible.

FIG. 6 illustrates a convolution process 600 for seismic data noise removal based on the tasks 530, 532 of FIG. 5. As shown in FIG. 6, the 2D input image 404 including the crossing shape feature 408 that includes pixels of constant value 1, and all the background pixels are all 0. The data processing system applies the 3D smoothing operator 508 described in relation to FIG. 5. The smoothing operator 508 is initially applied to all candidate orientations. The output of the operator 508 is combined with the orientation data 534 for the second reduction operation 522. The resulting image 614 is shown including a preserved crossing feature 615. Both shape and the amplitude consistency are achieved.

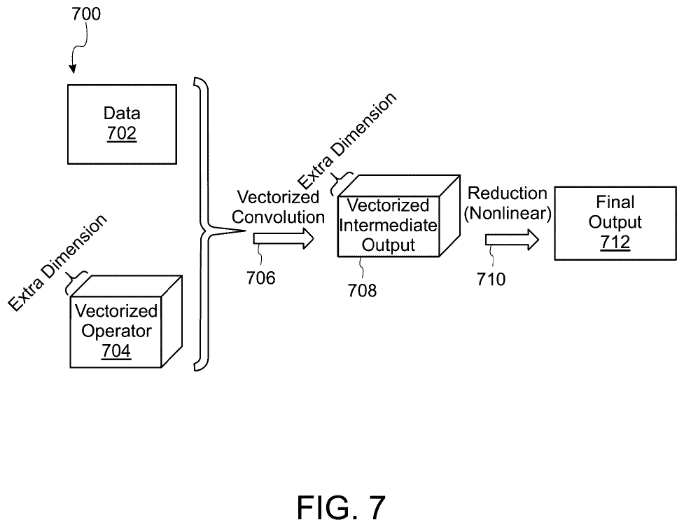

FIG. 7 is a flow diagram that illustrates a feature preserving process 700 for seismic data noise removal. The process 700 is configured for vectorized convolution. The input image or seismic data 702 is received and processed with the vectorized operator 704 with the vectorized convolution step. The convolution step 706 generates an intermediate vectorized output 708 that is reduced in a reduction step 710. The result is the final output data 712 having the same dimensions as the input data 702. A linear convolution \textcircled{*} is defined as:

$$d ( {x}_{1} , … , {x}_{k} ) \text{?} f ( {x}_{1} , … , {x}_{k} ) = {\sum }_{{i}_{1}} … {\sum }_{{i}_{k}} d ( {i}_{1} , … , {i}_{k} ) * f ( {x}_{1} - {i}_{1} , … , {x}_{k} - {i}_{k} ) = r ( {x}_{1} , … , {x}_{k} ) \qquad ( 3 )$$

The conventional convolution (\textcircled{*}) is extended by adding one more extra dimension n. The vectorized convolution \textcircled{*}_{vec} is defined as:

$$d ( {x}_{1} , … , {x}_{k} ) {\text{?}}_{vec} f ( {x}_{1} , … , {x}_{k} , n ) = {\sum }_{{i}_{1}} … {\sum }_{{i}_{k}} d ( {i}_{1} , … , {i}_{k} ) * f ( {x}_{1} - {i}_{1} , … , {x}_{k} - {i}_{k} , n ) = r ( {x}_{1} , … , {x}_{k} , n ) \qquad ( 4 )$$

The operator f in the vectorized convolution \textcircled{*}vec is not as the same dimension as input data d because the operator f has an extra dimension n, and the output r also has this extra dimension n. The output of vectorized convolution has higher dimension than the input data does, so, after the vectorized convolution, the high dimensional result is collapsed back into the same dimension as input data. The collapsing of the data from the higher dimension to the lower dimension is performed with a reduction step. The reduction is a nonlinear step, is subsequently described in more detail.

The vectorized convolution output 708 has higher dimension than the input data. The final result data 712 should have a same dimension as the input data. The reduction step 710 reduces the extra dimension and provides the result in a physical configuration that is the same as the input data. There are two reduction operations 520, 522 in process 500. They are not the same. The first reduction operation is for extracting the orientation information. After the 1st vectorized convolution 704 with orientation operator, if any component corresponding to certain specific orientation has regular structure energy, the output along this orientation is low. A function to find a minimum value is executed over the extra dimension to find out smoothest orientation as the output.

The orientation with the smallest variance in values is selected to find the smoothest orientation. This most coherent direction is selected for the subsequent smoothing operator. The criterion is independent of the smoothing operator. This independent search operator provides users the capability to accurately control the output and to ensure a more desirable result. Different searching operator and smoothing operator can be used together. In some implementations, multiple definitions of a most coherent orientation can be used (e.g., other than the lowest variance) by using different searching operators for operation 532 without rerunning 530. The only additional step performed is the 2nd reduction operation 522. Similarly, another smoothing operator can be selected for operation 530 without to redoing a search in operation 532 for the direction information. Different searching operators can be combined for different geological scenarios within one dataset to balance the cost and quality. The availably to mix-and-match operators provides a high degree of flexibility for generation of seismic images for different regions that may require different processing approaches.

The result orientation (ori) after the reduction step is the index of the smoothest orientation:

$$o r i ( {x}_{1} , … , {x}_{k} ) = {reduction}_{{1}^{s t}} ( r ( {x}_{1} , … , {x}_{k} , n ) ) = {arg min}_{n} ( d ( {x}_{1} , … , {x}_{k} ) {\text{?}}_{v e c} f ( {x}_{1} , … , {x}_{k} , n ) ) \qquad ( 5 )$$

The reduction for the 2nd vectorized convolution 708 outputs a final smooth result 712 based on the orientation from the previous reduction. The reduction 710 selects one component corresponding to the smoothest orientation in vicinity of the input pixel from the multi-component smooth results, after the 2nd vectorized convolution 708:

$$out ( {x}_{1} , … , {x}_{k} ) = {reduction}_{{2}^{n d}} ( r ( {x}_{1} , … , {x}_{k} , n ) , o r i ( {x}_{1} , … , {x}_{k} , n ) ) = r ( {x}_{1} , … , {x}_{k} , n = or i ( {x}_{1} , … , {x}_{k} ) ) \qquad ( 6 )$$

The 2^{nd} reduction extracts a desirable smooth result based on the orientation information.

FIG. 8A shows an example of coefficient values for a convolution operator 800 for the orientation operation (e.g., operation 532 of FIG. 5). FIG. 8B shows an example of coefficient values for a convolution operator 810 for the smoothing operation (e.g., operation 530 of FIG. 5).

There is an extra dimension in two of the operators 508, 514 of the process 500. For each component of this extra dimension, there is a complete independent operator in the same dimension as the input data. Each of the independent operators is assigned specifically to deal with certain regular structures in one single orientation. As previously described, to ensure the least possible distortion to the geological features in the seismic data/image 502 and to achieve the best efficiency in parallelism, the operators are configured to be simple. The word “simple” does not refer to fewer non-zero coefficients. The simpler operator reduces a cost used to generate the output. For example, in a given situation, a boxcar filter can be selected as smoothing operator, or a Gaussian filter can be selected as smoothing operator. In this example, the Gaussian filter is more expensive than the boxcar filter in computation. If both filters are sufficient to preserve features, the boxcar filter is selected as a simpler smoothing operator. Many types of operators are possible for this step, such as a triangle smoother, a median value smoother, or any other such smoother.

Additionally, the parameters of the operators are selected to be modest and conservative. The parameter may refer to the magnitude of the coefficients but does not only refer to the magnitude of this coefficients. For example, for a Gaussian filter case, the parameter sigma of the Gaussian function is an example of parameter.

The size of the operator is selected to be the smallest. This is smallest length in pixels in each direction, such as 3 elements. For both operators, only 3 adjacent elements in each orientation are involved. The following two figures show the detail of these two operators, respectively. FIG. 8A shows all the coefficients 800 for a 3D orientation operator 514 (e.g., all 13 components). The 13 components correspond to all the 13 possible directions for a discretized 3×3×3 3D data volume. There are 27 elements in a 3×3×3 cube and excluding the center element corresponding to the output location, there are 26 surrounding elements. Given 2 elements in a line determine 1 direction, the 26 surrounding elements determine 13 directions in total. Each component in the 3D operator is an individual conventional operator dedicated to structures of one single orientation. FIG. 8B shows all the coefficients 810 of 3D smooth operator 508.

Other coefficients can be used. The current set is selected for effectiveness and simplicity. The specific values of coefficients for both operators are one example implementation, and many other values can be selected. The coefficients can be selected at different values for different situations (e.g. different geological situations or different noise levels).

The smoothing operator is selected in a similar manner as the orientation operator. The parameters (e.g., the smoother type, a sliding-window size, etc.) are selected to be conservative to ensure the least amount of distortion to the geological features in the seismic data/image. A conservative parameter is a parameter that enables the operator to make an incremental but meaningful adjustment to the data. To compensate the conservative parameter choice, execution of the operator can be iterated as previously described (shown as 504) to achieve a satisfactory noise removal result in output data 710 (e.g., output 506).

The process 500 and be parallelized on a modern multi-core computer/multi-node cluster. The process 500 is suitable for parallelization on customized computational hardware. There are two level of parallelisms. The parallelisms are configured to take advantage of vector instruction sets (e.g., streaming single instruction, multiple data (SIMD) extensions and/or advanced vector extensions) of modern CPUs, or parallel computing mode on GPUs. A high efficiency is achieved on a modern multi-core computer/multi-node cluster with or without a GPU. Due to the simple design for both operators, the process 500 can implemented onto a programable (e.g. FPGA) or non-programable specifically customized computational chips (e.g. ASIC) to obtain high speed and efficiency.

FIGS. 9A-9C each shows an example of a seismic image. Each of images 900, 910, and 920 show a field data results comparison between conventional edge preserving smoothing processes and the process 500 for feature preserving smoothing.

In image 900, a time-slice of example seismic data are shown. Image 910 shows an edge preserving smoothing process output. Image 910 includes artificial boundaries and a patchified effect. The patchified effect of the edge preserving process makes the result difficult to use and removes geological features of interest. Image 920 shows an example result from process 500. Here, the noise is significantly reduced and there are not any artificial boundaries or patchified effects introduced. The result has preserved geological features, reducing errors for downstream processing, well selection, and well drilling in the subsurface.

FIGS. 10A-10B each shows an example of a seismic image for fault detection. The images 1000, 1010 show a comparison of further interpretation operations, such as fault detection. The resulting image 1000 is based on the edge preserving smoothing process. The image 1010 is based on the process 500 for feature preserving smoothing. In image 1010, the three faults are clearly visible, without any ambiguity. In image 1000, all the faults are not clear and full of uncertainty.

A parallelized program for the method 500 can be deployed as a standalone program on a multi-node cluster for seismic data processing. The seismic exploration field data example (FIGS. 9A-10B) to illustrate that process 500 provides more desirable noise removal result (e.g., fewer artifacts, fewer false boundaries, and clearer features) than prior methods.

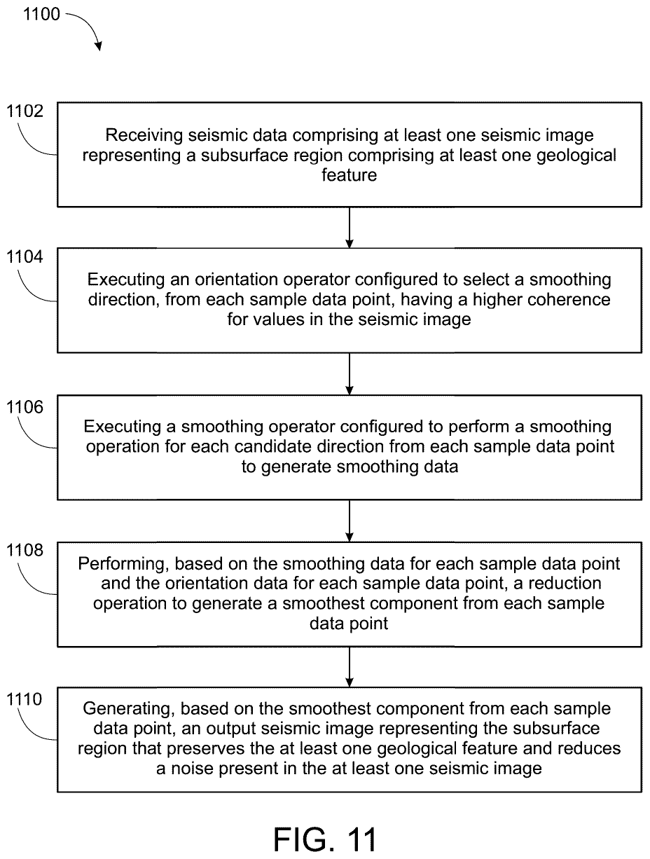

FIG. 11 is a flow diagram that illustrates an example process 1100 for a feature preserving process for noise removal from seismic images. The method can be performed by an FPGA, ASCI, or other computing system, such as computing system 1300 described in relation to FIG. 13.

The process 1100 includes receiving (1102) seismic data comprising at least one seismic image representing a subsurface region comprising at least one geological feature. The process 1100 includes executing (1104), over a set of sample data points in the seismic image, an orientation operator configured to select a smoothing direction, from each sample data point, having a higher coherence for values in the seismic image relative to another direction from each sample data point to generate orientation data for each sample data point. The process 1100 includes executing (1106), over the set of sample data points in the seismic image, a smoothing operator configured to perform a smoothing operation for each candidate direction from each sample data point of the set of sample data points to generate smoothing data for each sample data point. The process 1100 includes performing (1108), based on the smoothing data for each sample data point and the orientation data for each sample data point, a reduction operation to generate a smoothest component from each sample data point of the set of sample data points. The process 1100 includes generating (1110), based on the smoothest component from each sample data point, an output seismic image representing the subsurface region that preserves the at least one geological feature and reduces a noise present in the at least one seismic image.

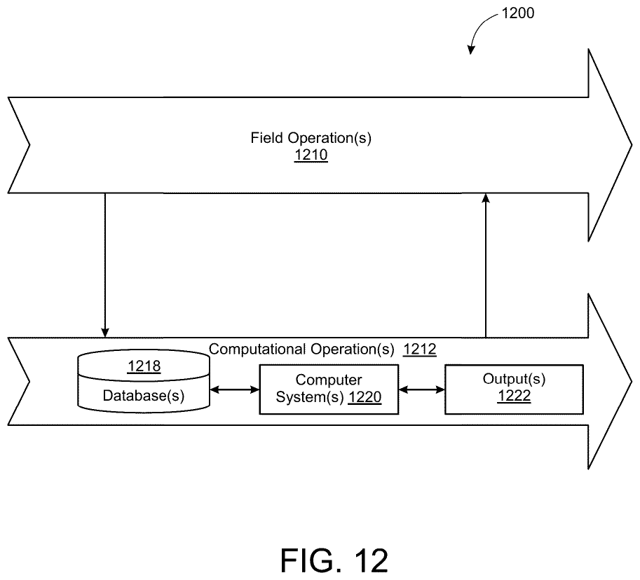

FIG. 12 illustrates hydrocarbon production operations 1200 that include both one or more field operations 1210 and one or more computational operations 1212, which exchange information and control exploration for the production of hydrocarbons. In some implementations, outputs of techniques of the present disclosure can be performed before, during, or in combination with the hydrocarbon production operations 1200, specifically, for example, either as field operations 1210 or computational operations 1212, or both.

Examples of field operations 1210 include forming/drilling a wellbore, hydraulic fracturing, producing through the wellbore, injecting fluids (such as water) through the wellbore, to name a few. In some implementations, methods of the present disclosure can trigger or control the field operations 1210. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1210 and responsively triggering the field operations 1210 including, for example, generating plans and signals that provide feedback to and control physical components of the field operations 1210. Alternatively or in addition, the field operations 1210 can trigger the methods of the present disclosure. For example, implementing physical components (including, for example, hardware, such as sensors) deployed in the field operations 1210 can generate plans and signals that can be provided as input or feedback (or both) to the methods of the present disclosure.

Examples of computational operations 1212 include one or more computer systems 1220 that include one or more processors and computer-readable media (e.g., non-transitory computer-readable media) operatively coupled to the one or more processors to execute computer operations to perform the methods of the present disclosure. The computational operations 1212 can be implemented using one or more databases 1218, which store data received from the field operations 1210 and/or generated internally within the computational operations 1212 (e.g., by implementing the methods of the present disclosure) or both. For example, the one or more computer systems 1220 process inputs from the field operations 1210 to assess conditions in the physical world, the outputs of which are stored in the databases 1218. For example, seismic sensors of the field operations 1210 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1212 where they are stored in the databases 1218 and analyzed by the one or more computer systems 1220.

In some implementations, one or more outputs 1222 generated by the one or more computer systems 1220 can be provided as feedback/input to the field operations 1210 (either as direct input or stored in the databases 1218). The field operations 1210 can use the feedback/input to control physical components used to perform the field operations 1210 in the real world.

For example, the computational operations 1212 can process the seismic data to generate three-dimensional (3D) maps of the subsurface formation. The computational operations 1212 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1212 to process new information about the formation and control the drilling to adjust to the observed conditions in real-time.

The one or more computer systems 1220 can update the 3D maps of the subsurface formation as information from one exploration well is received and the computational operations 1212 can adjust the location of the next exploration well based on the updated 3D maps. Similarly, the data received from production operations can be used by the computational operations 1212 to control components of the production operations. For example, production well and pipeline data can be analyzed to predict slugging in pipelines leading to a refinery and the computational operations 1212 can control machine operated valves upstream of the refinery to reduce the likelihood of plant disruptions that run the risk of taking the plant offline.

In some implementations of the computational operations 1212, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, based on processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

FIG. 13 is a block diagram of an example computing system 1300 used to provide computational functionalities associated with described algorithms, methods, functions, processes, flows, and procedures described in the present disclosure, according to some implementations of the present disclosure. The illustrated computer 1302 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1302 can include input devices such as keypads, keyboards, and touch screens that can accept user information. Also, the computer 1302 can include output devices that can convey information associated with the operation of the computer 1302. The information can include digital data, visual data, audio information, or a combination of information. The information can be presented in a graphical user interface (UI) (or GUI).

The computer 1302 can serve in a role as a client, a network component, a server, a database, a persistency, or components of a computer system for performing the subject matter described in the present disclosure. The illustrated computer 1302 is communicably coupled with a network 1324. In some implementations, one or more components of the computer 1302 can be configured to operate within different environments, including cloud-computing-based environments, local environments, global environments, and combinations of environments.

At a high level, the computer 1302 is an electronic computing device operable to receive, transmit, process, store, and manage data and information associated with the described subject matter. According to some implementations, the computer 1302 can also include, or be communicably coupled with, an application server, an email server, a web server, a caching server, a streaming data server, or a combination of servers.

The computer 1302 can receive requests over network 1324 from a client application (for example, executing on another computer 1302). The computer 1302 can respond to the received requests by processing the received requests using software applications. Requests can also be sent to the computer 1302 from internal users (for example, from a command console), external (or third) parties, automated applications, entities, individuals, systems, and computers.

Each of the components of the computer 1302 can communicate using a system bus 1304. In some implementations, any or all the components of the computer 1302, including hardware or software components, can interface with each other or the interface 1306 (or a combination of both), over the system bus 1304. Interfaces can use an application programming interface (API) 1314, a service layer 1316, or a combination of the API 1314 and service layer 1316. The API 1314 can include specifications for routines, data structures, and object classes. The API 1314 can be either computer-language independent or dependent. The API 1314 can refer to a complete interface, a single function, or a set of APIs.

The service layer 1316 can provide software services to the computer 1302 and other components (whether illustrated or not) that are communicably coupled to the computer 1302. The functionality of the computer 1302 can be accessible for all service consumers using this service layer. Software services, such as those provided by the service layer 1316, can provide reusable, defined functionalities through a defined interface. For example, the interface can be software written in JAVA, C++, or a language providing data in extensible markup language (XML) format. While illustrated as an integrated component of the computer 1302, in alternative implementations, the API 1314 or the service layer 1316 can be stand-alone components in relation to other components of the computer 1302 and other components communicably coupled to the computer 1302. Moreover, any or all parts of the API 1314 or the service layer 1316 can be implemented as child or sub-modules of another software module, enterprise application, or hardware module without departing from the scope of the present disclosure.

The computer 1302 includes an interface 1306. Although illustrated as a single interface 1306 in FIG. 13, two or more interfaces 1306 can be used according to needs, desires, or particular implementations of the computer 1302 and the described functionality. The interface 1306 can be used by the computer 1302 for communicating with other systems that are connected to the network 1324 (whether illustrated or not) in a distributed environment. Generally, the interface 1306 can include, or be implemented using, logic encoded in software or hardware (or a combination of software and hardware) operable to communicate with the network 1324. More specifically, the interface 1306 can include software supporting one or more communication protocols associated with communications. As such, the network 1324 or the hardware of the interface can be operable to communicate physical signals within and outside of the illustrated computer 1302.

The computer 1302 includes a processor 1308. Although illustrated as a single processor 1308 in FIG. 13, two or more processors 1308 can be used according to particular implementations of the computer 1302 and the described functionality. Generally, the processor 1308 can execute instructions and can manipulate data to perform the operations of the computer 1302, including operations using algorithms, methods, functions, processes, flows, and procedures as described in the present disclosure.

The computer 1302 also includes a database 1320 that can hold data (for example, seismic image data 1322) for the computer 1302 and other components connected to the network 1324 (whether illustrated or not). For example, database 1320 can be an in-memory, conventional, or a database storing data consistent with the present disclosure. In some implementations, database 1320 can be a combination of two or more different database types (for example, hybrid in-memory and conventional databases) according to particular implementations of the computer 1302 and the described functionality. Although illustrated as a single database 1320 in FIG. 13, two or more databases (of the same, different, or combination of types) can be used according to particular implementations of the computer 1302 and the described functionality. While database 1320 is illustrated as an internal component of the computer 1302, in alternative implementations, database 1320 can be external to the computer 1302.

The computer 1302 also includes a memory 1310 that can hold data for the computer 1302 or a combination of components connected to the network 1324 (whether illustrated or not). Memory 1310 can store any data consistent with the present disclosure. In some implementations, memory 1310 can be a combination of two or more different types of memory (for example, a combination of semiconductor and magnetic storage) according to implementations of the computer 1302 and the described functionality. Although illustrated as a single memory 1310 in FIG. 13, two or more memories 1310 (of the same, different, or combination of types) can be used according to implementations of the computer 1302 and the described functionality. While memory 1310 is illustrated as an internal component of the computer 1302, in alternative implementations, memory 1310 can be external to the computer 1302.

The application 1312 can be an algorithmic software engine providing functionality according to implementations of the computer 1302 and the described functionality. For example, application 1312 can serve as one or more components, modules, or applications. Further, although illustrated as a single application 1312, the application 1312 can be implemented as multiple applications 1312 on the computer 1302. In addition, although illustrated as internal to the computer 1302, in alternative implementations, the application 1312 can be external to the computer 1302.

The computer 1302 can also include a power supply 1318. The power supply 1318 can include a rechargeable or non-rechargeable battery that can be configured to be either user- or non-user-replaceable. In some implementations, the power supply 1318 can include power-conversion and management circuits, including recharging, standby, and power management functionalities. In some implementations, the power-supply 1318 can include a power plug to allow the computer 1302 to be plugged into a wall socket or a power source to, for example, power the computer 1302 or recharge a rechargeable battery.

There can be any number of computers 1302 associated with, or external to, a computer system containing computer 1302, with each computer 1302 communicating over network 1324. Further, the terms “client,” “user,” and other appropriate terminology can be used interchangeably, as appropriate, without departing from the scope of the present disclosure. Moreover, the present disclosure contemplates that many users can use one computer 1302 and one user can use multiple computers 1302.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Any claimed implementation is applicable to at least a computer-implemented method; a non-transitory, computer-readable medium storing computer-readable instructions to perform the computer-implemented method; and a computer system comprising a computer memory interoperable coupled with a hardware processor configured to perform the computer-implemented method or the instructions stored on the non-transitory, computer-readable medium.

While this specification contains many specific implementation details, these should not be construed as limitations on the scope of what may be claimed, but rather as descriptions of features that may be specific to implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

A number of embodiments have been described. Nevertheless, it will be understood that various modifications may be made without departing from the scope of the embodiments herein. Accordingly, other embodiments are within the scope of the following claims.

What is claimed is:

1. A method for performing seismic imaging of a subsurface region, the method comprising:
receiving seismic data comprising at least one seismic image representing a subsurface region comprising at least one geological feature;
executing, over a set of sample data points in the seismic image, an orientation operator configured to select a smoothing direction, from each sample data point, having a higher coherence for values in the seismic image relative to another direction from each sample data point to generate orientation data for each sample data point;
executing, over the set of sample data points in the seismic image, a smoothing operator configured to perform a smoothing operation for each candidate direction from each sample data point of the set of sample data points to generate smoothing data for each sample data point;
performing, based on the smoothing data for each sample data point and the orientation data for each sample data point, a reduction operation to generate a smoothest component from each sample data point of the set of sample data points; and
generating, based on the smoothest component from each sample data point, an output seismic image representing the subsurface region that preserves the at least one geological feature and reduces a noise present in the at least one seismic image.

2. The method of claim 1, wherein the output seismic image is free of artificial boundaries or patchified effects.

3. The method of claim 1, wherein the orientation operator and the smoothing operator are executed in parallel.

4. The method of claim 1, wherein either the orientation operator, the smoothing operator, or both are three-dimensional operators.

5. The method of claim 1, further comprising selecting a type of the smoothing operator or the orientation operator or both based on a particular geographic location or geology represented in the at least one seismic image.

6. The method of claim 1, wherein the smoothing operator, the orientation operator, or both include a vectorized convolution operator.

7. The method of claim 1, wherein the orientation operator and the smoothing operator are executed using a field programable gate array or an application specific integrated circuit.

8. A system for performing seismic imaging of a subsurface region, the system comprising:
a memory; and
at least one processor in communication with the memory, the at least one processor configured to execute instructions stored by the memory to perform operations comprising:
receiving seismic data comprising at least one seismic image representing a subsurface region comprising at least one geological feature;
executing, over a set of sample data points in the seismic image, an orientation operator configured to select a smoothing direction, from each sample data point, having a higher coherence for values in the seismic image relative to another direction from each sample data point to generate orientation data for each sample data point;
executing, over the set of sample data points in the seismic image, a smoothing operator configured to perform a smoothing operation for each candidate direction from each sample data point of the set of sample data points to generate smoothing data for each sample data point;
performing, based on the smoothing data for each sample data point and the orientation data for each sample data point, a reduction operation to generate a smoothest component from each sample data point of the set of sample data points; and
generating, based on the smoothest component from each sample data point, an output seismic image representing the subsurface region that preserves the at least one geological feature and reduces a noise present in the at least one seismic image.

9. The system of claim 8, wherein the output seismic image is free of artificial boundaries or patchified effects.

10. The system of claim 8, wherein the orientation operator and the smoothing operator are executed in parallel.

11. The system of claim 8, wherein either the orientation operator, the smoothing operator, or both are three-dimensional operators.

12. The system of claim 8, the operations further comprising selecting a type of the smoothing operator or the orientation operator or both based on a particular geographic location or geology represented in the at least one seismic image.

13. The system of claim 8, wherein the smoothing operator, the orientation operator, or both include a vectorized convolution operator.

14. The system of claim 8, wherein the orientation operator and the smoothing operator are executed using a field programable gate array or an application specific integrated circuit.

15. One or more non-transitory computer readable media storing instructions for performing seismic imaging of a subsurface region, wherein the instructions, when executed by at least one processor, cause the at least one processor to perform operations comprising:
receiving seismic data comprising at least one seismic image representing a subsurface region comprising at least one geological feature;
executing, over a set of sample data points in the seismic image, an orientation operator configured to select a smoothing direction, from each sample data point, having a higher coherence for values in the seismic image relative to another direction from each sample data point to generate orientation data for each sample data point;
executing, over the set of sample data points in the seismic image, a smoothing operator configured to perform a smoothing operation for each candidate direction from each sample data point of the set of sample data points to generate smoothing data for each sample data point;
performing, based on the smoothing data for each sample data point and the orientation data for each sample data point, a reduction operation to generate a smoothest component from each sample data point of the set of sample data points; and
generating, based on the smoothest component from each sample data point, an output seismic image representing the subsurface region that preserves the at least one geological feature and reduces a noise present in the at least one seismic image.

16. The one or more non-transitory computer readable media of claim 15, wherein the output seismic image is free of artificial boundaries or patchified effects.

17. The one or more non-transitory computer readable media of claim 15, wherein the orientation operator and the smoothing operator are executed in parallel.

18. The one or more non-transitory computer readable media of claim 15, wherein either the orientation operator, the smoothing operator, or both are three-dimensional operators.

19. The one or more non-transitory computer readable media of claim 15, the operations further comprising selecting a type of the smoothing operator or the orientation operator or both based on a particular geographic location or geology represented in the at least one seismic image.

20. The one or more non-transitory computer readable media of claim 15, wherein the smoothing operator, the orientation operator, or both include a vectorized convolution operator.
